(19) United States
(12) Patent Application Publication
(10) Pub. No.: US 2019/0071551 A1
(43) Pub. Date: Mar. 7, 2019

(54) METHODS OF FUNCTIONALIZING CARBON NANOTUBES AND COMPOSITIONS COMPRISING FUNCTIONALIZED CARBON NANOTUBES

(71) Applicant: Seerstone LLC, Provo, UT (US)

(72) Inventor: Randall Smith, Sandy, UT (US)

(21) Appl. No.: 16/084,925

(22) PCT Filed: Mar. 17, 2017
(86) PCT No.: PCT/US2017/022950

§ 371 Date: Sep. 13, 2018

Related U.S. Application Data
(60) Provisional application No. 62/310,585, filed on Mar. 18, 2016.

(51) Int. Cl. C08K 3/04; C01B 32/168; C22C 26/00

(52) U.S. Cl. CPC C08K 3/041; C01B 32/168; C22C 2026/002; C08K 2201/004; C08K 2201/014; C22C 26/00

(57) ABSTRACT

Methods of treating carbon nanotubes include disposing a plurality of carbon nanotubes in a chamber; reducing a pressure of an atmosphere within the chamber; increasing a temperature within the chamber; and removing gases from interstices within at least some of the plurality of carbon nanotubes. A composition of matter includes a plurality of carbon nanotubes defining interstices therein; an inert gas disposed within at least some of the interstices in the carbon nanotubes; and a matrix material mixed with the plurality of carbon nanotubes.

### CROSS-REFERENCE TO RELATED APPLICATIONS

This application is a national phase entry under 35 U.S.C. § 371 of International Patent Application PCT/US2017/022950, filed Mar. 17, 2017, designating the United States of America and published in English as International Patent Publication WO 2017/161258 A1 on Sep. 21, 2017, which claims the benefit under Article 8 of the Patent Cooperation Treaty to U.S. Provisional Patent Application Ser. No. 62/310,585, filed Mar. 18, 2016, for “A Method for Functionalizing Carbon Nanotubes.”

### TECHNICAL FIELD

Embodiments of the disclosure relate to methods of functionalizing carbon nanotubes, that is, treating carbon nanotubes by removing gases from interstices, as well as to compositions of matter including such functionalized carbon nanotubes.

### BACKGROUND

Carbon nanotubes (“CNTs”) are valuable because of their unique material properties, including strength, current-carrying capacity, and thermal and electrical conductivity. Current bulk use of CNTs includes use as an additive to resins in the manufacture of composites. Research and development on the applications of CNTs is active with a wide variety of applications in use or under consideration.

Conventional methods of using CNTs often involve dispersing the CNTs in a metal or polymer material. CNTs are currently processed in a wide variety of composite structures using metals, plastics, thermoset resins, epoxies, and other substances as the matrix to hold the CNTs together and to create solid objects. The CNTs may act as a reinforcing material to improve properties of the materials. Typical objectives of using carbon nanotubes in a matrix are to increase the strength, decrease weight, or to increase electrical and thermal conductivity of the composite.

Recent advances in laser printing have enabled what may be called additive manufacturing, that is, the construction or “printing” of a wide variety of items from metals and polymers. In these processes, a manufactured item is built up by depositing a raw material, such as a metal powder, and then using a laser to melt the metal and create a layer of the final product when the metal solidifies. This process adds material to an underlying object, and the process may be repeated as needed to add as much material as is required. Additive manufacturing differs from subtractive manufacturing, in which tools are used to cut and remove material from a block to form the final product.

Heat used for additive manufacturing, when applied to CNTs, typically results in combustion of the CNTs due to the presence of oxygen or organic or inorganic material containing oxygen. This limits the effectiveness of CNTs in enhancing the material properties of the host matrix.

### BRIEF SUMMARY

This disclosure relates generally to methods of treating carbon nanotubes. Some methods include disposing a plurality of carbon nanotubes in a chamber, reducing a pressure of an atmosphere within the chamber, increasing a temperature within the chamber, and removing gases from interstices within at least some of the plurality of carbon nanotubes.

A composition of matter includes a plurality of carbon nanotubes defining interstices therein, an inert gas disposed within at least some of the interstices in the carbon nanotubes, and a matrix material mixed with the plurality of carbon nanotubes.

### BRIEF DESCRIPTION OF THE DRAWINGS

FIGS. 1 through 4 are simplified illustrations of carbon nanotubes.

FIG. 5 is a simplified schematic of a system that may be used to functionalized CNTs as disclosed herein.

FIG. 6 is a simplified cross-sectional view of a mixture of carbon nanotubes with another material.

FIG. 7 is a SEM (scanning electron micrograph) image showing aluminum powder.

FIG. 8 is a SEM image of an object formed by additive manufacturing using the aluminum powder shown in FIG. 7.

FIGS. 9A and 9B are SEM images of CNTs.

FIGS. 10A and 10B are SEM images of an object formed from a mixture of aluminum powder and CNTs.

FIGS. 11A and 11B are SEM images showing aluminum powder mixed with functionalized CNTs.

FIGS. 12 and 13 are SEM images of objects formed from mixtures of aluminum powder and functionalized CNTs.

### DETAILED DESCRIPTION

The disclosure includes methods of treating carbon nanotubes (CNTs) or other forms of carbon. The methods may be used to remove gaseous impurities contacting CNTs, such that the CNTs may be used in high-temperature and/or high/pressure applications without reaction of the CNTs with the impurities. For example, some forms of carbon that may benefit from such processes include graphene, fibrous carbon, buckminsterfullerenes, single-wall CNTs, multi-wall CNTs, or bimodal CNTs (i.e., CNTs having a bimodal distribution of diameters and/or a bimodal distribution of lengths). CNTs may have any selected size and morphology, even helical. The methods may be particularly valuable for carbon forms having interstices within particles.

As used herein, the term “sintering” means and includes annealing or pyrolizing CNTs at temperatures and pressures sufficient to induce carbon-carbon covalent bonding between at least some of the adjacent CNTs at contact points.

As used herein, the term “catalyst residual” means and includes any non-carbon elements associated with the CNTs. Such non-carbon elements may include nanoparticles of a metal catalyst in growth tips of the CNTs, and metal atoms or groups of atoms randomly or otherwise distributed throughout and on the surfaces of the CNTs.

As used herein, the term “green” means and includes any solid carbon product that has not been sintered.

CNTs may be created through any method known to the art, including arc discharge, laser ablation, hydrocarbon pyrolysis, the Boudouard reaction, the Bosch reaction and related carbon oxide reduction reactions, or wet chemistry methods (e.g., the Diels-Alder reaction). The methods described herein are applicable to carbon nanotubes regardless of the method of manufacture or synthesis.

CNTs may occur as single-wall and multi-wall carbon nanotubes of various diameters ranging from a few nanometers to 100 nanometers in diameter or more. CNTs may have a wide variety of lengths and morphologies, and may occur as substantially parallel “forests,” randomly tangled masses, or “pillows” of structured agglomerations. CNTs may also form or be compounded to form many different mixtures of CNTs with various combinations and distribution of the above characteristics (number of walls, diameters, lengths, morphology, orientation, etc.). Various mixtures, when compounded and used to form the solid carbon products described herein, may yield products with specifically engineered properties. For example, the median void size of interstitial spaces between CNTs comprising solid carbon products typically is approximately proportional to the characteristic diameters of the CNTs used in forming the solid carbon products. The median void size influences the overall porosity and density of the solid carbon products.

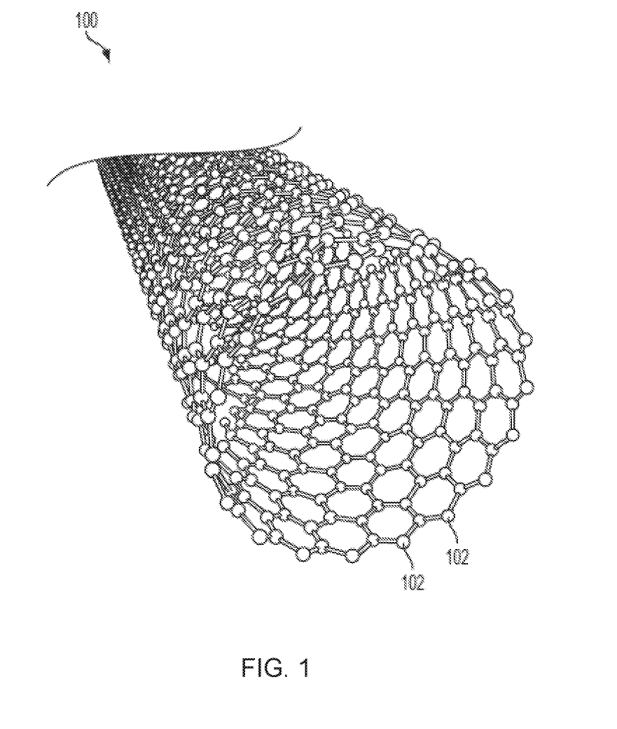

Various CNT features and configurations are illustrated in FIGS. 1-4. FIG. 1 shows a single-wall CNT 100, in which carbon atoms 102 are linked together in the shape of a single cylinder. The carbon atoms 102 are covalently bonded into a hexagonal lattice, and thus form a CNT 100 that appears as a single layer rolled into the form of a tube or pipe. The CNT 100 may be conceptualized as a graphene sheet rolled to form a tube. The CNT 100 may have a lattice pattern oriented so that the carbon atoms 102 spiral at various angles with regard to the axis of the CNT 100. The angle is called the “chirality,” and common named forms include armchair and zigzag, as described in Mildred S. Dresselhaus & Phaedon Avouris, Introduction to Carbon Materials Research, in Carbon Nanotubes: Synthesis, Structure, Properties, and Applications, 1, 6 (Mildred S. Dresselhaus, Gene Dresselhaus, & Phaedon Avouris, eds., 2001), the entire contents of which are incorporated herein by this reference. Many chiralities are possible; CNTs 100 with different chiralities may exhibit different properties (e.g., CNTs 100 may have either semiconductor or metallic electrical properties).

The CNT 100 has an inside diameter related to the number of carbon atoms 102 in a circumferential cross section. The CNT 100 depicted in FIG. 1 has a zigzag pattern, as shown at the end of the CNT 100. The diameter may also affect properties of the CNT 100. Single-walled CNTs 100 can have many different diameters, such as from about 1.0 nm (nanometer) to 10 nm or more. A CNT 100 may have a length from about 10 nm to about 1 μm (micron), such as from about 20 nm to about 500 nm or from about 50 nm to about 100 nm. CNTs 100 typically have an aspect ratio (i.e., a ratio of the length of the CNT to the diameter of the CNT) of about 100:1 to 1000:1 or greater.

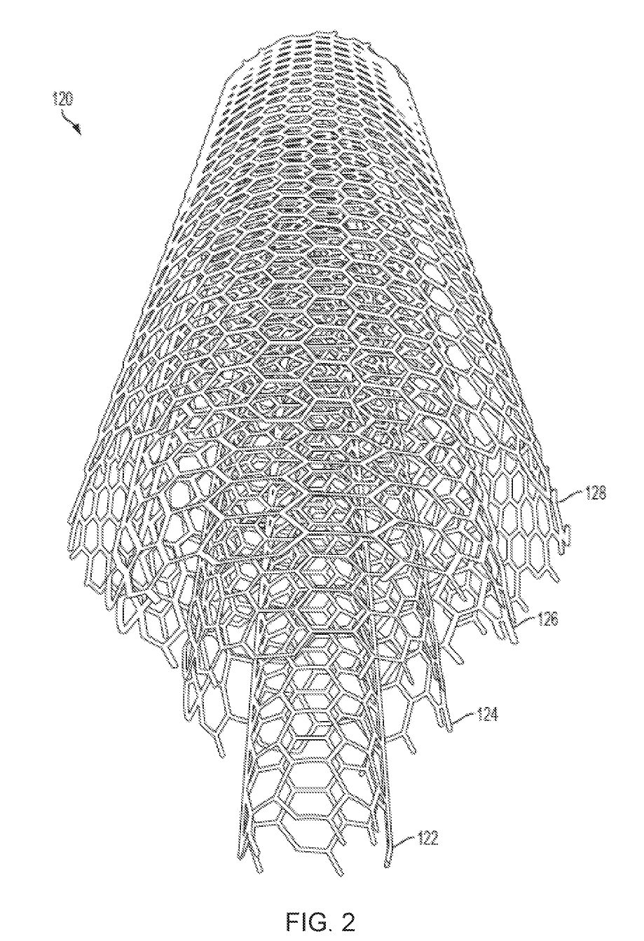

CNTs having more than one wall are called multi-wall CNTs. FIG. 2 schematically depicts a multi-wall CNT 120 having multiple layers 122, 124, 126, 128 arranged generally concentrically about a common axis. Double-walled and triple-walled carbon nanotubes are occasionally described as distinct classes; however, they may be considered as categories of multi-walled CNTs 120. Diameters of multi-wall CNTs 120 can range from approximately 3 nm to well over 100 nm. Multi-wall CNTs 120 having outside diameters of about 40 nm or more are sometimes referred to as carbon nanofibers in the art; however, the term carbon nanofibers may also refer to solid cylinders of carbon (e.g., in the form of stacked graphene sheets).

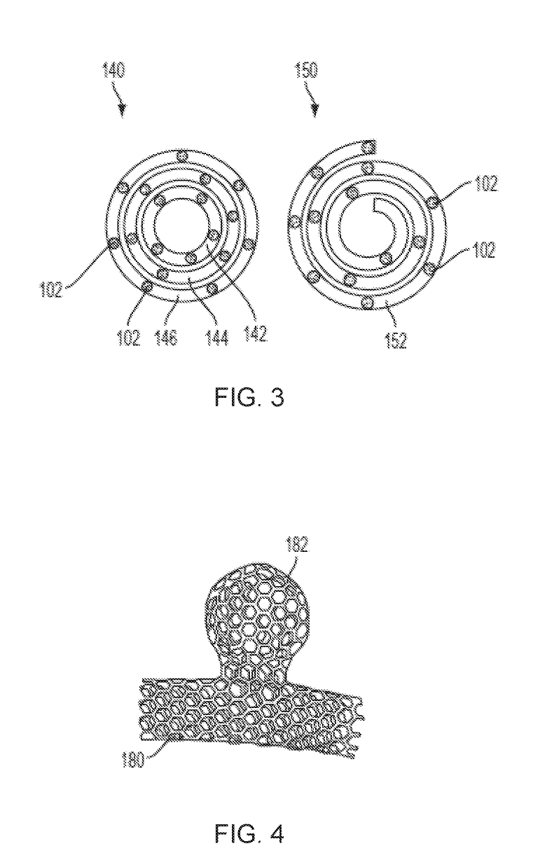

FIG. 3 depicts two forms of multi-wall CNTs 140, 150. In the CNT 140, one single-wall CNT 142 is disposed within a larger diameter single-wall CNT 144, which may in turn be disposed within another even larger diameter single-wall CNT 146. This multi-wall CNT 140 is similar to the CNT 120 shown in FIG. 2, but includes three single-wall CNTs 142, 144, 146 instead of four. Another form of multi-wall CNTs shown in FIG. 3 is CNT 150, which may be conceptualized as a single graphene sheet 152 rolled in a spiral to form a tube in which a graphene sheet 152 overlaps itself.

FIG. 4 schematically depicts a single-wall CNT 180 with an attached nanobud 182. The nanobud 182 has a structure similar to a spherical buckminsterfullerene (“buckyball”), and is bonded to the single-wall CNT 180 by carbon-carbon bonds. As suggested by the structure shown in FIG. 4, modifications may be made to the wall of a single-wall CNT 180 or to the outer wall of a multi-wall CNT. At the point of bonding between the nanobud 182 and the CNT 180, carbon double-bonds can break and result in “holes” in the wall of the CNT 180. These holes may affect the mechanical and electrical properties of the CNT 180. In single-wall CNTs, these holes may introduce a relative weakness when compared unmodified cylindrical CNTs. In multi-wall CNTs, the outer wall may be affected, but any inner walls may remain intact.

CNTs may have one or both ends open (e.g., as shown in FIG. 1). Any of the CNTs depicted in FIGS. 1-4 may contain or confine certain gases or other materials. For example, gases present during the formation of the CNTs, or materials to which the CNTs are exposed, may become at least partially trapped within the CNTs. In some embodiments, water, oxygen, or organic compounds may be within the CNTs. Elimination of such materials may enable the use of CNTs in various manufacturing processes with significantly reduced risk of combustion or other destruction of the CNTs in the final product. As used herein, treatment of CNTs to remove at least some non-carbon elements from the CNTs is referred to as “functionalizing,” and CNTs from which non-carbon elements have been removed are referred to as “functionalized.” Functionalizing may reduce or eliminate oxygen and other potentially reactive materials from the CNTs. Functionalized CNTs may be used, for example, in additive manufacturing.

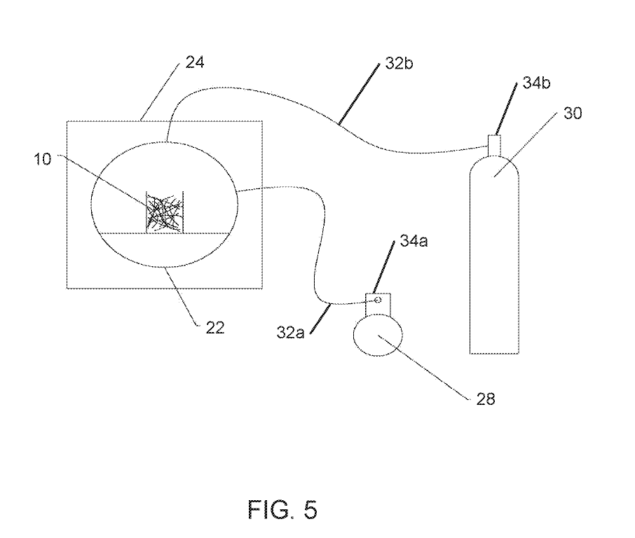

In some embodiments, CNTs may be functionalized by disposing CNTs in a chamber, reducing a pressure of an atmosphere within the chamber, increasing a temperature within the chamber, and removing gases from interstices within the CNTs. For example, and as depicted in FIG. 5, CNTs 10 may be placed within a chamber 22 in a furnace 24. The CNTs 10 may be of a predetermined size and morphology, including helical, and may be dry or in a slurry of water, organic liquid, or other liquid or gas. The chamber 22 may be a vessel that may be sealed to yield a vacuum or pressure inside. The chamber 22 may be connected to a vacuum pump 28 and/or a pressure tank 30 by flow lines 32a, 32b and valves 34a, 34b. The chamber 22 may be evacuated while heating the furnace 24. The heating and evacuation may remove the liquids and gases, including those trapped in the interstices between and in the interiors of the CNTs 10, leaving primarily pure CNTs.

The chamber 22 may be heated and evacuated to create a partial vacuum. In some embodiments, heating and evacuation may occur concurrently. In other embodiments, evacuation may occur first, or heating may occur first. The pressure within the chamber 22 may be reduced to an absolute pressure of less than about 0.5 bar, less than about 0.4 bar, less than about 0.3 bar, or even less than about 0.2 bar. The pressure within the chamber 22 may be continuously reduced, or may be reduced in a stepwise manner. The temperature within the chamber 22 may be increased to at least about 100° C., at least about 150° C., at least about 200° C., at least about 250° C., or even at least about 300° C. The temperature within the chamber 22 may be continuously increased, or may be increased in a stepwise manner.

Heating and evacuation of the chamber 22 may drive gases and other compounds from the CNTs 10 out of the chamber 22, including at least a portion of gases and compounds trapped in interstices between CNTs 10 and in the interiors of the CNTs 10.

Once the temperature and pressure in the chamber 22 reach a selected level, the chamber 22 may be backfilled or purged with one or more inert gases, such as argon or nitrogen. The inert gas may flow from the pressure tank 30 to the chamber 22 via the flow lines 32a, 32b and valves 34a, 34b. The inert gas may intersperse with the CNTs 10 in the chamber 22, and may displace gases and other compounds between and within the CNTs 10. In some embodiments, the chamber 22 may be heated and/or evacuated again after backfilling with the inert gas, and the backfilling may be repeated.

The furnace 24 with the chamber 22 therein may be cooled to ambient temperature while continuing to backfill the chamber 22 with the inert gas. In some embodiments, the CNTs 10 may be removed from the chamber 22 and placed into a container with inert gas, or even into a container with ambient atmosphere, without the inert gas leaving the interior of the CNTs 10. Rather, the argon or other inert gas may remain within the CNTs 10.

The heating, evacuating, and backfilling may be repeated several times to significantly reduce or eliminate the reactive gases and other compounds in the CNTs 10. CNTs 10 functionalized by this process may be substantially free of oxygen and other reactive materials. Thus, when CNTs 10 that have been functionalized are heated in an inert atmosphere, the CNTs 10 may not combust or oxidize. In contrast, unfunctionalized CNTs 10, when heated in an inert atmosphere, may tend to react with reactive materials trapped between and within the CNTs 10. Thus, CNTs 10 functionalized as described may be used in processes requiring heating without oxidation or degradation of the CNTs 10.

The CNTs 10 may then be used for applications in which functionalized CNTs are useful. For example, the CNTs may be blended into additive manufacturing feedstocks (e.g., to be used in so-called “3D printing” processes). The functionalization of the CNTs 10 as described may enable additive manufacturing at conditions (e.g., temperature, atmosphere) not suitable for additive manufacturing of conventional CNTs.

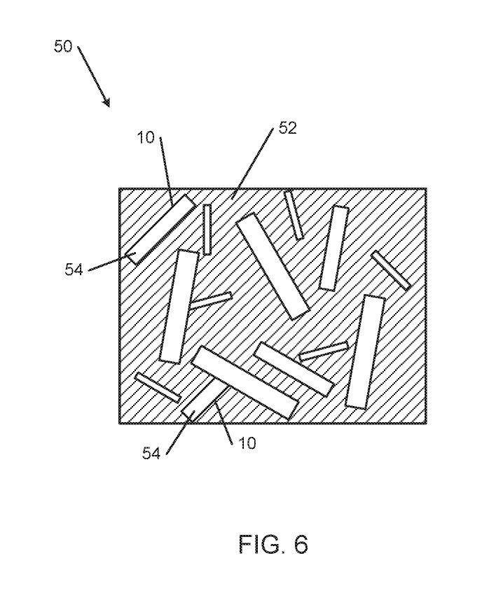

For example, in some embodiments, the CNTs 10, after functionalization, may be mixed with aluminum powder or another metal. FIG. 6 shows a simplified cross section of a mixture 50 having CNTs 10 and a metal 52. The CNTs 10 may define interstices therein, and may contain an inert gas 54 within at least some of the interstices in the CNTs 10. The mixture 50 may be used as a raw material for additive manufacturing. The mixture 50 may be subjected to selective laser sintering (SLS), laser engineered net shaping, or another additive manufacturing process. In some embodiments, a structure may be formed from the mixture 50 one layer at a time.

The metal 52 and CNTs 10 may be mixed in various ways, such as by a cone blender, a paddle blender, a rotary mixer, a shaker, etc. For example, tumbling the CNTs 10 and other materials together for a predetermined time may do less damage to CNTs 10 than a forcible mixing, but forcible mixing may be useful in other embodiments. Tumbling may result in metal balls with a somewhat uniform coating of CNTs 10, which is helpful for good dispersion. The CNTs 10 may coat particles of the metal 52 and become evenly distributed throughout the metal 52. Thus, when the mixture 50 is used, the CNTs 10 may be relatively evenly dispersed throughout the final product. In some embodiments, the functionalized CNTs 10 may be mixed with other materials, other metals, polymers, ceramics, or ceramic pre-cursors, for subsequent processing or manufacture into a final or intermediary product.

The CNTs 10 may be mixed at a predetermined ratio with other materials, such as powdered metal, powdered polymer, powdered ceramic or ceramic precursor, powdered glass material, or another material to be used for manufacturing a product. In some embodiments, CNTs 10 may be mixed with a metal such that the mixture has from about 0.5% CNTs to about 20% CNTs by weight, such as from about 1% CNTs to about 10% CNTs by weight, or from about 2% CNTs to about 6% CNTs by weight.

In some embodiments, the functionalized CNTs 10 alone may be used to make a final or intermediary product. The use of CNTs 10 in forming part or all of a manufactured product may include, for example, an increase in strength (e.g., shear, tensile, and compression strength); a decrease in weight and/or cost; a change in electrical conductivity in comparison with other metals; a change in thermal properties; a change in a radiation frequency response (e.g., absorption and reflection); a change in porosity; and a changes in hardness (e.g., wear and abrasion resistance). Each of these properties may vary based on the morphology of the CNTs used, as well as based on the amount of the CNTs 10 in the manufactured item compared to other materials, such as metals or polymers. For example, research has shown that CNTs added to aluminum significantly increase the strength-to-weight ratio of the final material for amounts of CNTs up to about 5% CNTs (by weight). Additional information about properties of materials having CNTs therein may be found in “Measurement Science Roadman for Metal-Based Additive Manufacturing,” National Institute of Standards and Technology (May 2013); “Fabrication of High Strength Metal-Carbon Nanotube Composites,” D. A. Weigand et al., Defense Technical Information Center (December 2008); and “MWCNT Reinforced Metal Matrix Composites Using LENS™: Case Studies on MWCNT-Bronze and MWCNT-Al-12% Si,” Abhimanyu Bhat, Master's Thesis, Washington State University (August 2010); the entire disclosure of each of which is hereby incorporated herein by this reference.

Adding CNTs to a material and then forming a final product from that material typically increases the strength-to-weight ratio of the final product, at least up to a point. One advantage of using CNTs functionalized as described herein is that functionalization reduces the amount of CNTs that are destroyed in the manufacturing process (such as by heat causing the CNTs to combust with free oxygen). It appears that even if the manufacturing process is conducted in an ambient (oxygen-containing) atmosphere, there is less reaction of functionalized CNTs with oxygen, possibly because the functionalized CNTs do not contain free oxygen molecules within the CNTs and thus in close contact with the CNTs at the time of exposure to heat (e.g., during laser heating of the materials). In a matrix with another material, CNTs appear to act as tiny pieces of rebar within a matrix, allowing significant reductions of weight of components.

CNTs 10 are excellent heat conductors. Incorporating CNTs into components in which heat transfer is important may reduce the weight of the components as well as increase the thermal conductivity of the components. For example, in brake pads, CNTs could replace some or all of the copper conventionally used, thereby reducing the weight, increasing the effectiveness of the brake pads, and reducing the environmental impact of the brake pads.

CNTs 10 could also be used as heat sinks. The CNTs could be mixed with another heat transfer material, such as copper, or used pure or nearly pure. For example, CNTs formed into a shape by additive manufacturing could be used to dissipate heat from a computer CPU significantly better than conventional heat sinks. The processes disclosed herein may enable or improve additive manufacturing of such a device, because the CNTs have little or no oxygen available to combust. Therefore, the formation of amorphous carbon during additive manufacturing may be reduced. This may increase the volume of CNTs remaining in the final product for heat transfer.

CNTs, particularly single wall CNTs, are excellent electrical conductors. CNTs functionalized as described herein may be extruded with copper or another metal into wires or power lines. Such lines may provide greater tensile strength, which may be beneficial in increasing spacing between supports. Furthermore, during the manufacturing process, CNTs may be cross-linked, as described in U.S. Patent Publication No. US2015/0225242, “Solid Carbon Products Comprising Carbon Nanotubes and Methods of Forming Same,” published Aug. 13, 2015, the entire disclosure of which is incorporated herein by this reference. Cross-linking may increase the tensile strength of the CNTs.

CNTs may be added to paint as a flame retardant. Such paint may improve the fire rating of any surface to which it is applied. Without being bound to any particular theory, it appears that CNTs may act as tiny heat-transfer materials, lengthening the time to combustion of the material to which CNTs or paint containing CNTs have been applied. Argon, nitrogen, or another inert gas inside the CNTs functionalized as described herein may further increase that time to combustion.

CNTs may absorb various wavelengths of electromagnetic radiation. Thus, for example, CNTs on the leading edge of an aircraft wing or rotor blade may assist in stealth flight. The CNTs may also reduce the weight of the aircraft by displacing heavier materials. CNTs functionalized as disclosed herein may be useful for additive manufacturing of aircraft parts to assist in stealth technology.

CNTs mixed with a polymer and formed into a boat hull or used in a boat hull coating may increase the ability of the hull to resist fouling, including barnacle fouling. Boat hulls may also be formed by additive manufacturing techniques with pure CNTs functionalized using the present process as the raw material. The CNTs may be mixed with a biocide to assist in inhibiting and killing plant, animal, fungal, and microbial growth.

CNTs functionalized as disclosed herein may be compressed into discs or other shapes and used as filters. Inert gases inside the CNTs reduce the risk of combustion and may also reduce the level of active gases existing within the filter. The compressed CNT discs may have interstitial spaces of a generally uniform size, and thus may filter out particles larger than those interstitial spaces. Filters so configured may be cleaned using a backflush.

Adding CNTs to a metal may reduce thermal expansion of the metal. This appears to be related to the effect discussed above and analogized to rebar. Corkscrew-shaped CNTs may provide a certain level of spring or elasticity to the CNTs, with the result that the CNTs may variably resist thermal expansion and may draw the material back from thermal expansion. The CNTs may also be cross-linked. CNTs having a corkscrew shape are described in in U.S. Patent Publication 2015/0064097, “Carbon Nanotubes Having a Bimodal Size Distribution,” published Mar. 5, 2015, the entire disclosure of which is incorporated herein by this reference.

CNTs in materials may increase the surface hardness of the materials, and may improve wear resistance. Functionalized CNTs as described herein may disperse more evenly in metals than conventional CNTs. Argon may enhance dispersion into the metal parts. It appears some of the increase in wear resistance may be related to the effect discussed above and analogized to rebar, but may also be a result of attraction between CNTs and certain materials, such as aluminum and polymers. For example, aluminum may act as a protective jacket keeping oxygen out of the CNTs while the CNTs help hold the aluminum together.

### EXAMPLES

### Comparative Example 1

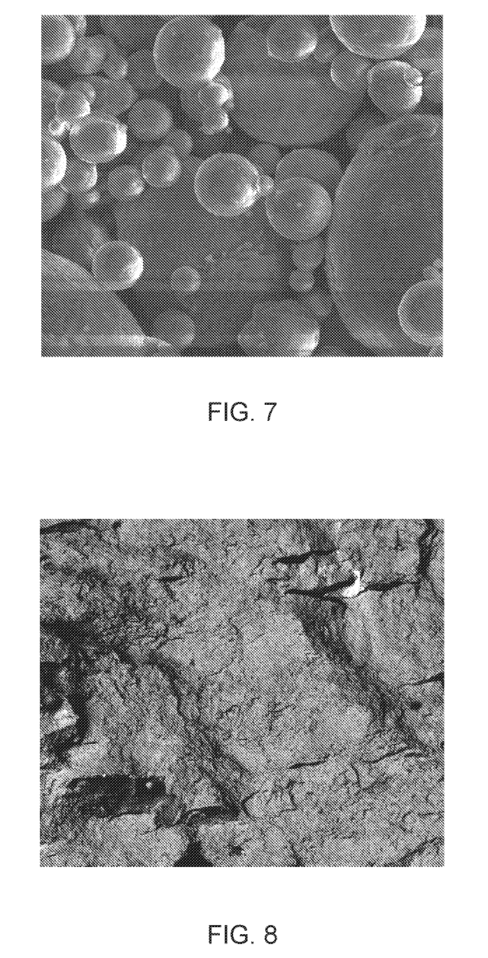

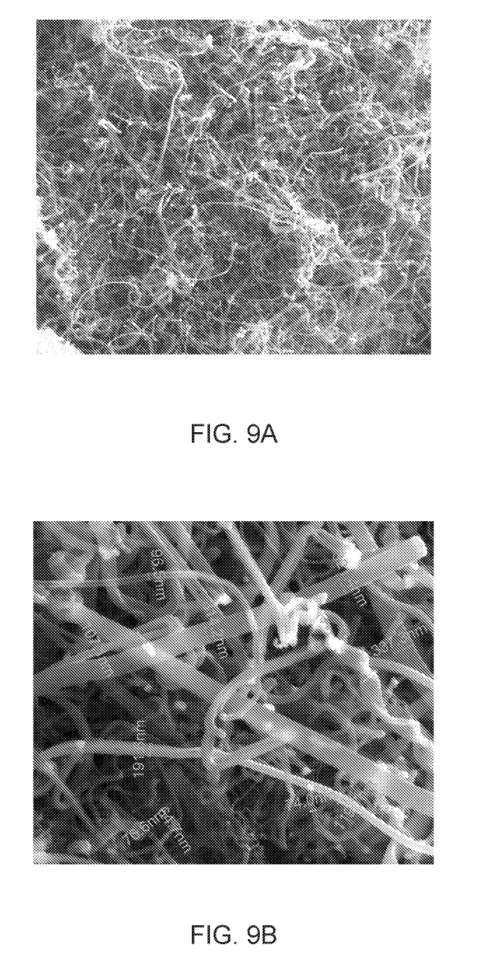

FIG. 7 shows a SEM (scanning electron micrograph) image at approximately 5,000× magnification of aluminum powder used in additive manufacturing. FIG. 8 shows a SEM image at approximately 500× magnification of an object formed by additive manufacturing using the aluminum powder shown in FIG. 7. A chemical analysis of a portion of the object indicated the following elements:

| Element | Concentration (by weight) |
|---|---|
| Carbon | 2.08% |
| Oxygen | 2.13% |
| Magnesium | 0.78% |
| Aluminum | 87.87% |
| Silicon | 10.14% |

Approximately 2% carbon is within expected ranges for additive manufacturing using aluminum powder.

### Comparative Example 2

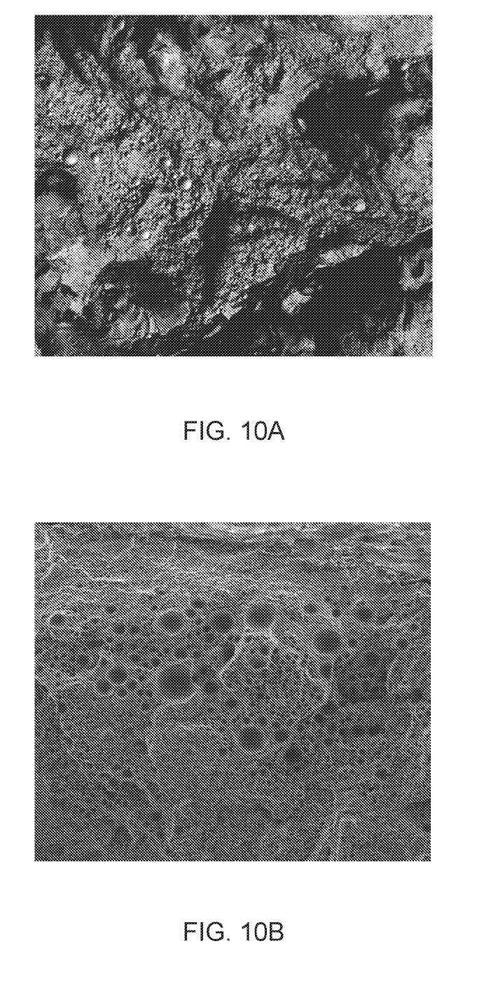

A sample of aluminum powder (e.g., as shown in FIG. 7) was blended with carbon nanotubes in a weight ratio of approximately 98% Al to 2% CNTs. FIGS. 9A and 9B show SEM images of CNTs 10 at approximately 10,000× and 50,000× magnification, respectively. The mixture was used to form an object by additive manufacturing. FIGS. 10A and 10B show SEM images of the object at approximately 500× and 10,000× magnification, respectively. The surface of the object had the appearance of bubbles and craters.

A chemical analysis of a portion of the object near the bubbles and craters indicated the following elements:

| Element | Concentration (by weight) |
|---|---|
| Carbon | 7.97% |
| Oxygen | 3.16% |
| Magnesium | 1.25% |
| Aluminum | 80.04% |
| Silicon | 7.59% |

Without being bound to any particular theory, it appears that in areas where the CNTs were present, the heat of the laser caused conversion of the CNTs to CO₂ gas. The CO₂ gas formed pockets in the aluminum while the aluminum was in a molten phase.

### Example 3

A sample of the CNTs 10 (e.g., as shown in FIGS. 9A and 9B) was placed in a chamber 22 within a furnace 24, as depicted in FIG. 5. The chamber 22 was connected to a vacuum pump 28 and a pressure tank 30 containing argon by flow lines 32a, 32b and valves 34a, 34b. The valve 34a connecting the chamber 22 to the vacuum pump 28 was opened, and the valve 34b connecting the chamber 22 to the pressure tank 30 was closed. With the furnace 24 at room temperature (about 23° C.), the pressure in the chamber 22 was monitored. When the pressure in the chamber 22 decreased to 20 inHg vacuum (corresponding to about 0.336 bar absolute pressure), the furnace 24 began heating to a set point of 200° C.

Once the temperature of the furnace 24 reached 200° C., the valve 34b was opened to allow argon to backfill into the chamber 22 from the pressure tank 30 for 1 hour. After 1 hour, the valve 34a connecting the vacuum pump 28 closed, and the chamber 22 was vented to the atmosphere with argon still flowing.

After 45 minutes, the valve 34b was closed to stop argon flow, and the valve 34a was opened to allow the vacuum pump 28 to decrease the pressure in the chamber 22 again. The pressure in the chamber 22 decreased to 20.5 inHg vacuum (corresponding to about 0.319 bar absolute pressure) in 45 minutes, at which time the valve 34b was opened to allow argon to again backflow into the chamber 22. After 30 minutes, the furnace 24 was turned off and allowed to cool. The valve 34b was closed to stop argon flow, and the valve 34a was opened to decrease pressure in the chamber 22.

Once the furnace 24 cooled, the valve 34b was opened to allow argon to backfill into the chamber 22 again, and the valve 34a was closed to allow the pressure in the chamber 22 to increase to atmospheric, at which time the CNTs were removed.

### Example 4

A sample of CNTs 10 was placed in a chamber 22 within a furnace 24, as depicted in FIG. 5. The chamber 22 was connected to a vacuum pump 28 and a pressure tank 30 containing argon by flow lines 32a, 32b and valves 34a, 34b. The valve 34a connecting the chamber 22 to the vacuum pump 28 was opened, and the valve 34b connecting the chamber 22 to the pressure tank 30 was closed. With the furnace 24 at room temperature (about 23° C.), the pressure in the chamber 22 was monitored. When the pressure in the chamber 22 decreased to 19.5 inHg vacuum (corresponding to about 0.353 bar absolute pressure), the valve 34b was opened to allow argon to backfill into the chamber 22. During the backfill, the pressure in the chamber 22 was about 5 inHg vacuum (about 0.844 bar absolute pressure).

The valve 34b was closed and the furnace 24 began heating to a set point of 200° C. The pressure in the chamber 22 was maintained at a vacuum of 20 inHg (corresponding to about 0.336 bar absolute pressure) for 90 minutes, at which time the valve 34b was opened to allow argon to again backflow into the chamber 22. During the backfill, the pressure in the chamber 22 was about 2 inHg vacuum (about 0.946 bar absolute pressure).

The valve 34b was closed and the pressure in the chamber 22 was reduced to a vacuum of 20.5 inHg (corresponding to about 0.319 bar absolute pressure) for 60 minutes, at which time the valve 34b was opened to allow argon to again backflow into the chamber 22. During the backfill, the pressure in the chamber 22 was about 1.5 inHg vacuum (about 0.962 bar absolute pressure). The pressure was then brought to atmospheric and the CNTs 10 were removed.

### Example 5

A sample of CNTs 10 was placed in a chamber 22 within a furnace 24, as depicted in FIG. 5. The chamber 22 was connected to a vacuum pump 28 and a pressure tank 30 containing argon by flow lines 32a, 32b and valves 34a, 34b. The valve 34a connecting the chamber 22 to the vacuum pump 28 was opened, and the valve 34b connecting the chamber 22 to the pressure tank 30 was closed. With the furnace 24 at room temperature (about 23° C.), the pressure in the chamber 22 was monitored. When the pressure in the chamber 22 decreased to 20.5 inHg vacuum (corresponding to about 0.319 bar absolute pressure), the furnace 24 began heating to a set point of 200° C., and the valve 34b was opened to allow argon to backfill into the chamber 22. The backfill continued for 30 minutes, at which time the valve 34a was closed and the chamber 22 was vented to the atmosphere. After 60 minutes, the valve 34b was reopened to backfill the chamber 22. The valve 34a was opened, and the pressure was reduced to 21.5 inHg (corresponding to about 0.285 bar absolute pressure) for about 90 minutes, at which time the valve 34b was opened to allow argon to again backflow into the chamber 22. During the backfill, the pressure in the chamber 22 was about 1.5 inHg vacuum (about 0.962 bar absolute pressure).

The pressure was then brought to atmospheric while the furnace 24 cooled, and the CNTs 10 were removed.

### Example 6

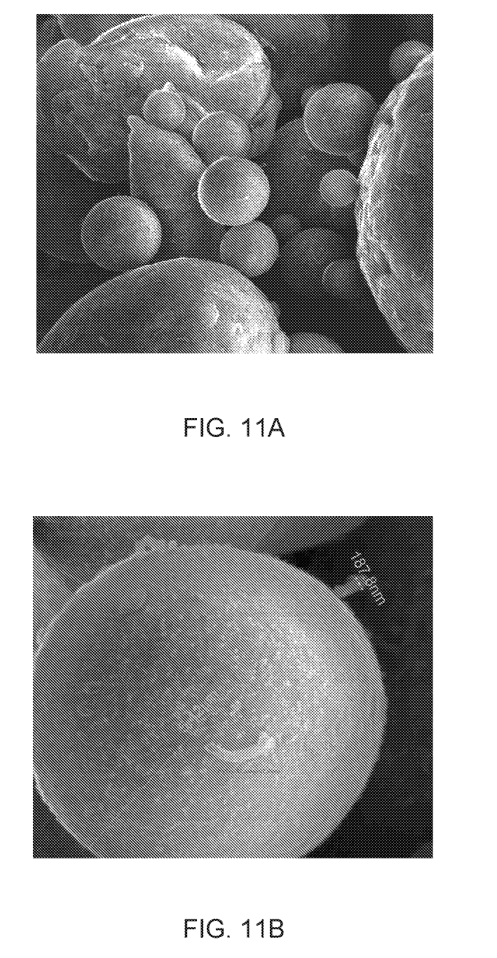

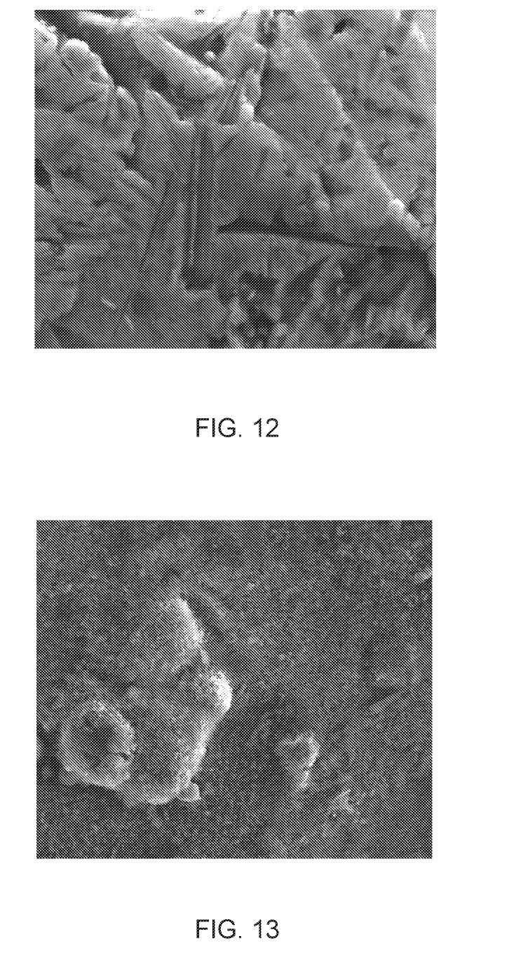

A sample of aluminum powder (e.g., as shown in FIG. 7) was blended with the functionalized carbon nanotubes formed in Example 3 in a weight ratio of approximately 98% Al to 2% CNTs. FIGS. 11A and 11B show SEM images of the mixture of aluminum powder with the functionalized CNTs at approximately 10,000× and 50,000× magnification, respectively. The mixture was used to form an object by additive manufacturing. FIG. 12 shows a SEM image of the object at approximately 10,000× magnification.

A chemical analysis of a portion of the object indicated the following elements:

| Element | Concentration (by weight) |
|---|---|
| Carbon | 20.28% |
| Oxygen | 6.80% |
| Magnesium | 0.93% |
| Aluminum | 61.55% |
| Silicon | 10.43% |

Without being bounds to any particular, theory, it appears that the functionalized CNTs used in this example remain in nanotube form during sintering of the aluminum powder into a solid. The relatively high concentration of carbon in the analyzed portion (with respect to the initial mixture) indicates that CNTs were present at that location on the surface.

### Example 7

A sample of aluminum powder (e.g., as shown in FIG. 7) was blended with the functionalized carbon nanotubes formed in Example 4 in a weight ratio of approximately 98% Al to 2% CNTs. The mixture was used to form an object by additive manufacturing. FIG. 13 shows a SEM image of the object at approximately 10,000× magnification. Carbon nanotubes appear to be attached to the surface of the object in FIG. 13.

Based on the results of Examples 6 and 7, it appears that functionalizing prevents off-gassing or conversion of the carbon in CNTs into CO₂ when the CNTs are exposed to the conditions of additive manufacturing (e.g., high-temperature laser sintering). Without being bound to any particular theory, this effect may be due to the absence of oxygen within the CNTs.

1. A method of treating carbon nanotubes, the method comprising:
disposing a plurality of carbon nanotubes in a chamber;
reducing a pressure of an atmosphere within the chamber;
increasing a temperature within the chamber; and
removing gases from interstices within at least some of the plurality of carbon nanotubes.

2. The method of claim 1, wherein reducing a pressure of an atmosphere within the chamber comprises reducing the pressure to 0.4 bar or lower.

3. (canceled)

4. The method of claim 1, further comprising providing an inert gas to the chamber.

5. (canceled)

6. The method of claim 4, further comprising displacing at least a portion of oxygen occupying the interstices with the inert gas.

7. The method of claim 6, further comprising retaining the inert gas within at least some of the plurality of carbon nanotubes after exposing the carbon nanotubes to an ambient atmosphere.

8. The method of claim 1, wherein the plurality of carbon nanotubes comprises single-wall carbon nanotubes.

9. The method of claim 1, wherein the plurality of carbon nanotubes comprises multi-wall carbon nanotubes.

10. The method of claim 1, wherein the plurality of carbon nanotubes comprises carbon nanotubes having a bimodal distribution of diameters.

11. The method of claim 1, further comprising mixing the plurality of carbon nanotubes with a matrix material.

12. The method of claim 11, wherein mixing the plurality of carbon nanotubes with a matrix material comprises mixing the plurality of carbon nanotubes and the matrix material in a rotary mixer.

13. The method of claim 11, wherein mixing the plurality of carbon nanotubes with a matrix material comprises mixing between about 2% by weight and about 6% by weight of the plurality of carbon nanotubes with the matrix material.

14. The method of claim 11, wherein the matrix material comprises a material selected from the group consisting of a metal, a polymer, a ceramic, and a ceramic precursor.

15. The method of claim 14, wherein the matrix material comprises aluminum.

16. The method of claim 11, wherein the matrix material comprises a powder.

17. The method of claim 1, wherein disposing a plurality of carbon nanotubes in a chamber comprises disposing a slurry comprising the plurality of carbon nanotubes in the chamber.

18. A composition of matter, comprising:
a plurality of carbon nanotubes defining interstices therein;
an inert gas disposed within at least some of the interstices in the carbon nanotubes; and
a matrix material mixed with the plurality of carbon nanotubes.

19. The composition of claim 18, wherein the interstices are substantially free of oxygen.

20. (canceled)

21. The composition of claim 18, wherein the inert gas disposed within at least some of the interstices in the carbon nanotubes comprises a substantially pure inert gas.

22. The composition of claim 18, wherein the matrix material comprises a material selected from the group consisting of a metal, a polymer, a ceramic, and a ceramic precursor.

23. The composition of claim 22, wherein the matrix material comprises aluminum.
